(19) United States
(12) Patent Application Publication
(10) Pub. No.: US 2007/0245970 A1
(43) Pub. Date: Oct. 25, 2007

(54) PORTABLE DISPOSABLE PET WASTE DISPOSER

(76) Inventor: Jae-Kyoung You, Palisades Park, NJ (US)

Correspondence Address: WALTER J, TENCZA JR., 10 STATION PLACE, SUITE 3, METUCHEN, NJ, 08840, US

(21) Appl. No.: 11/308,674

(22) Filed: Apr. 20, 2006

(51) Int. Cl. A01K 29/00

(52) U.S. Cl. 119/161

(57) ABSTRACT

A first section of a top is detached from a second section of the top, and thereafter the first section of the top is used to sweep pet droppings into an open box structure. After the pet droppings are swept into the open box structure, the open box structure may be closed by attaching the second section of the top to a bottom of the open box structure. The open box structure may be configured so that the open box structure can be placed in an expanded state in which material can be inserted through the opening into the chamber or in a fully compressed state in which material cannot be inserted through the opening into the chamber. The open box structure may be comprised of a water proof material.

### FIELD OF THE INVENTION

This invention relates to improved methods and apparatus concerning disposing of pet droppings, such as pet feces.

### BACKGROUND OF THE INVENTION

There are various devices known in the prior art for disposing of pet droppings.

### SUMMARY OF THE INVENTION

In one embodiment of the present invention, a method is provided comprising detaching a first section of a top from a second section of the top, and thereafter using the first section of the top to sweep pet droppings into an open box structure. After the pet droppings are swept into the open box structure, the open box structure may be closed by attaching the second section of the top to a bottom of the open box structure.

In one embodiment, the present invention provides an apparatus comprising a top, a bottom, a left side, a right side, and a rear. The top may be comprised of first, second, and third sections. The first section of the top may be attached to the second section of the top in a manner which allows the first section of the top to be easily removed from the second section of the top, such as through a perforated section or segment.

The third section of the top, the left side, the right side, the rear, and at least a portion of the bottom may form an open box structure having an opening leading to a chamber bordered by the third section of the top, the left side, the right side, the rear, and the portion of the bottom. The second section of the top may be adapted to be folded over and adhered to the bottom and thereby adapted to substantially cover the opening of the box structure so that the chamber is substantially closed. The open box structure may be configured so that the open box structure can be placed in an expanded state in which material can be inserted through the opening into the chamber. The open box structure may also be configured so that the open box structure can be placed in a fully compressed state in which material cannot be inserted through the opening into the chamber. The open box structure may be comprised of a water proof material.

### BRIEF DESCRIPTION OF THE DRAWINGS

FIG. 1 shows a top isometric perspective view of an apparatus in accordance with an embodiment of the present invention, with the apparatus in a fully opened state;

FIG. 2 shows a top orthographic view of the apparatus of FIG. 1, with the apparatus in a fully opened state;

FIG. 3 shows a left side orthographic view of the apparatus of FIG. 1, with the apparatus in a fully opened state;

FIG. 4 shows a right side orthographic view of the apparatus of FIG. 1, with the apparatus in a fully opened state;

FIG. 5 shows a rear orthographic view of the apparatus of FIG. 1, with the apparatus in a fully opened state;

FIG. 6 shows a bottom orthographic view of the apparatus of FIG. 1, with the apparatus in a fully opened state;

FIG. 7 shows a bottom isometric perspective view of the apparatus of FIG. 1, with the apparatus in a fully opened state;

FIG. 8 shows a top isometric perspective view of the apparatus of FIG. 1, with the apparatus in a fully opened state, and shown with a top section lifted upwards;

FIG. 9 shows a bottom isometric perspective view of the apparatus of FIG. 1, with the apparatus in a partially opened state, and shown with a bottom section lifted upwards;

FIG. 10 shows a bottom orthographic view of the apparatus of FIG. 1, with the apparatus in a fully closed state;

FIG. 11 shows a bottom orthographic view of part of the apparatus of FIG. 1, with the part of the apparatus in a fully closed state, with a bottom section folded over, and after a top section has been separated and removed from the apparatus;

FIG. 12 shows a bottom orthographic view of part of the apparatus shown in FIG. 11, with another top section folded over; and

FIG. 13 shows an isometric perspective view of a top section of the apparatus of FIG. 1 being used to move pet droppings into part of the apparatus of FIG. 1.

### DETAILED DESCRIPTION OF THE DRAWINGS

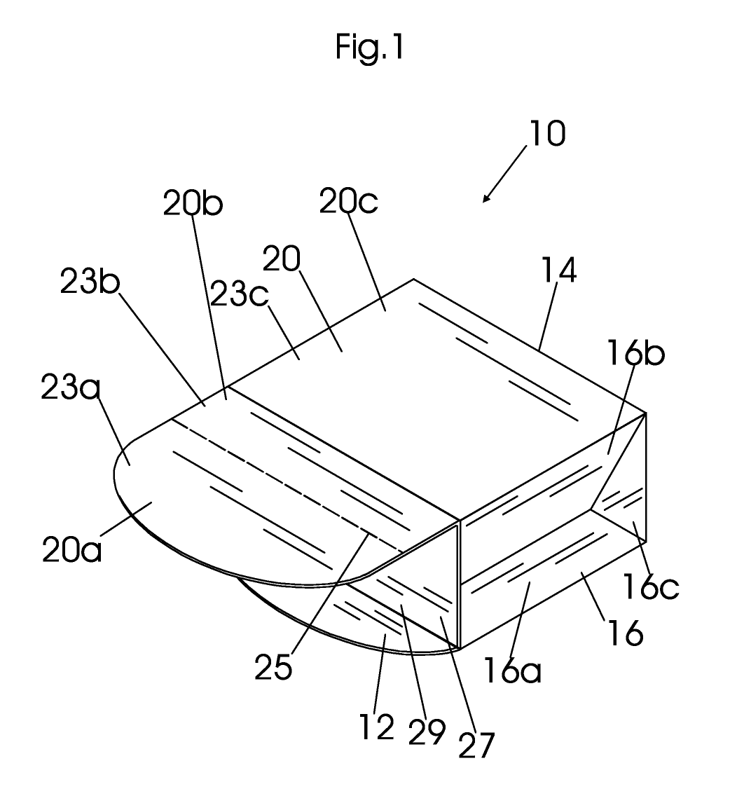

FIG. 1 shows a top isometric perspective view of an apparatus 10 in accordance with an embodiment of the present invention, with the apparatus 10 in a fully opened state.

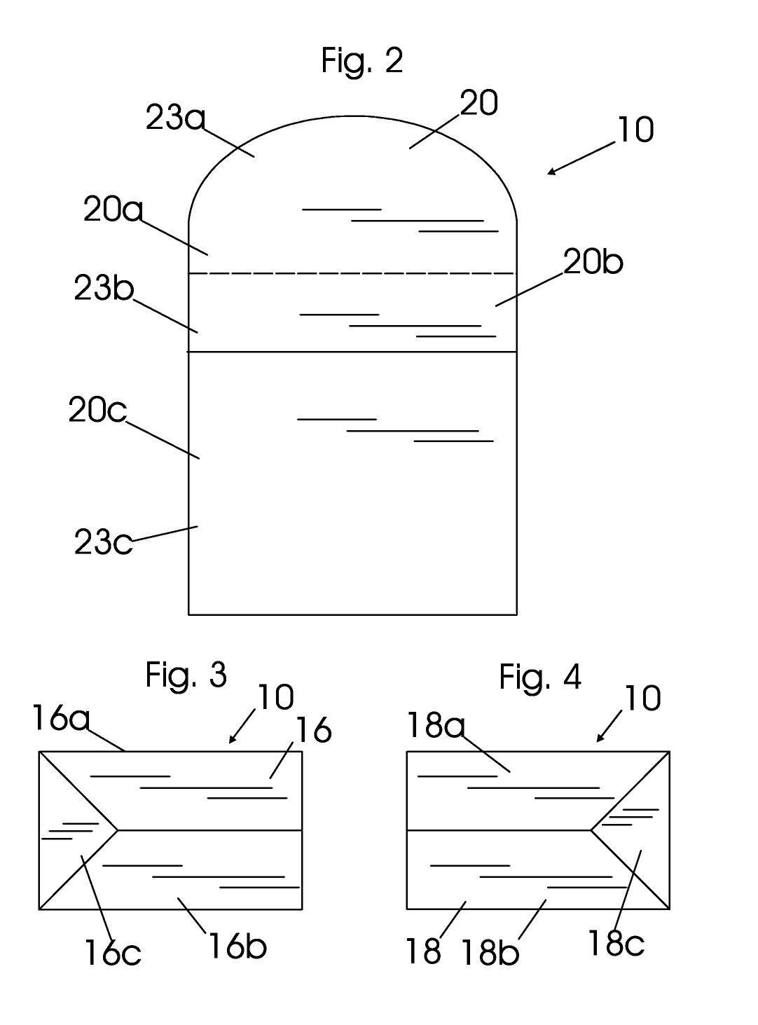

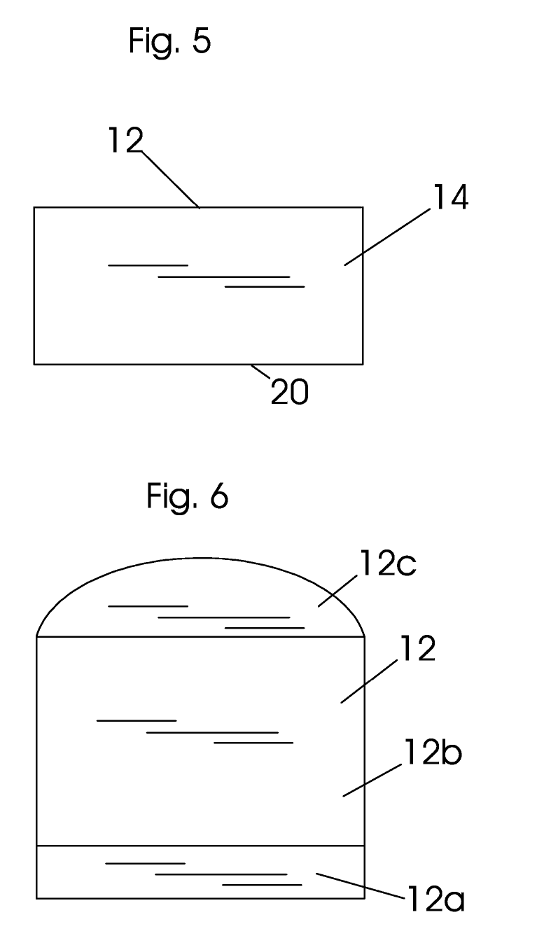

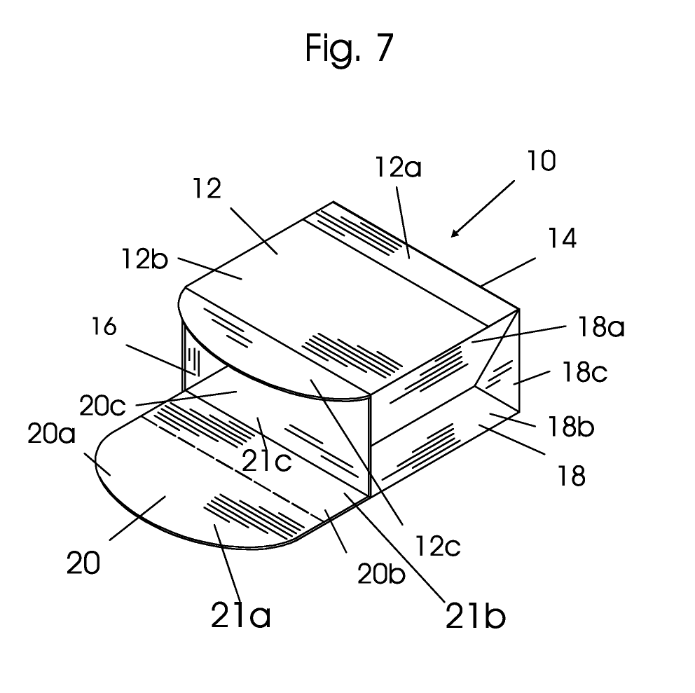

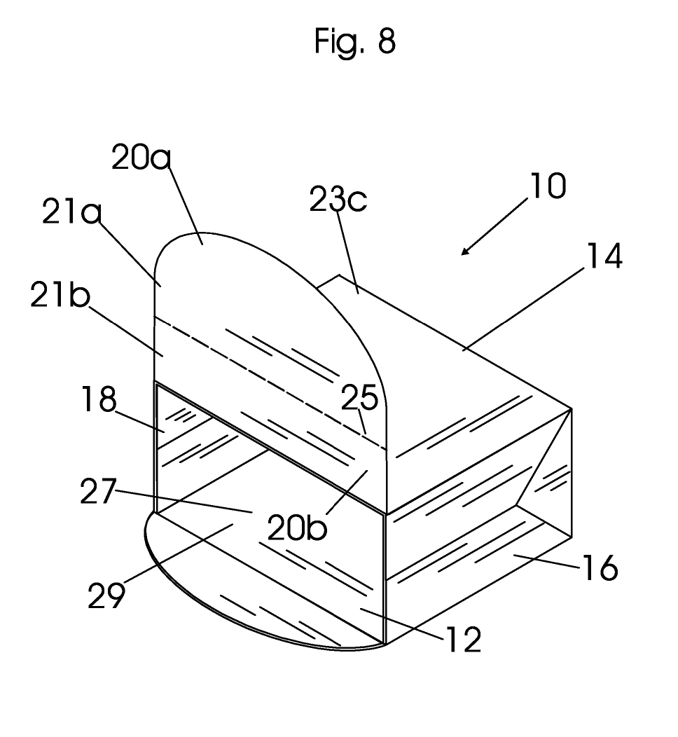

FIGS. 2-6 show a top, left side, right side, rear, and bottom orthographic views of the apparatus 10 in a fully opened state. FIG. 7 shows a bottom isometric perspective view of the apparatus 10 in a fully opened state.

Referring to FIGS. 1-7, the apparatus 10 includes a top 20, a left side 18, a right side 16, a rear 14, and a bottom 12. The top 20 includes sections 20a, 20b, and 20c. The left side 18 includes sections 18a, 18b, and 18c. The right side 16 includes sections 16a, 16b, and 16c. The bottom 12 includes sections 12a, 12b, and 12c. Left side 18, right side 16, rear 14, top section 20c, and bottom sections 12b and 12a substantially form a box shape having an opening 27, shown in FIG. 1, which leads to a chamber 29, in which pet droppings can be placed and can be retained.

FIG. 8 shows a top isometric perspective view of the apparatus 10 in a fully opened state, and shown with the sections 20a and 20b lifted or folded upwards. The sections 20a and 20b have inner surfaces 21a and 21b and outer surfaces 23a and 23b, respectively, as shown by the combination of FIGS. 2 and 8.

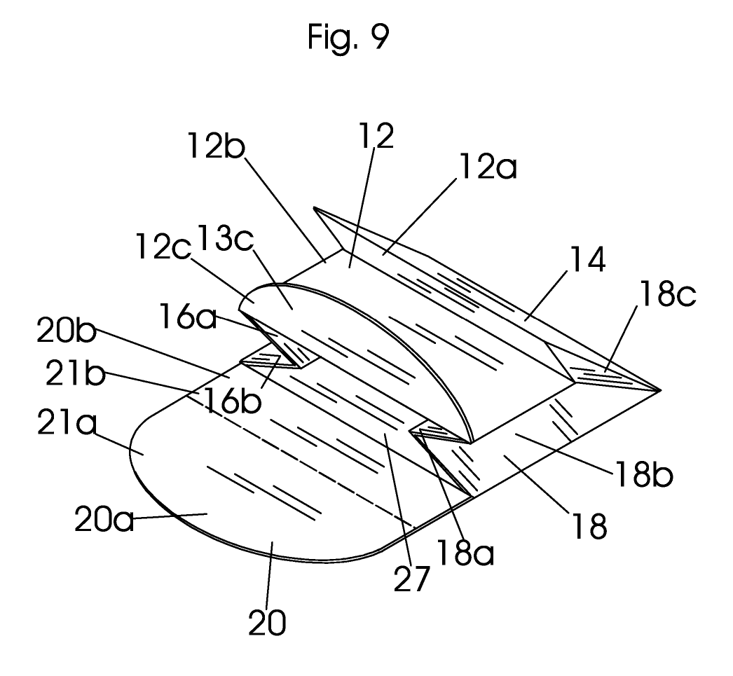

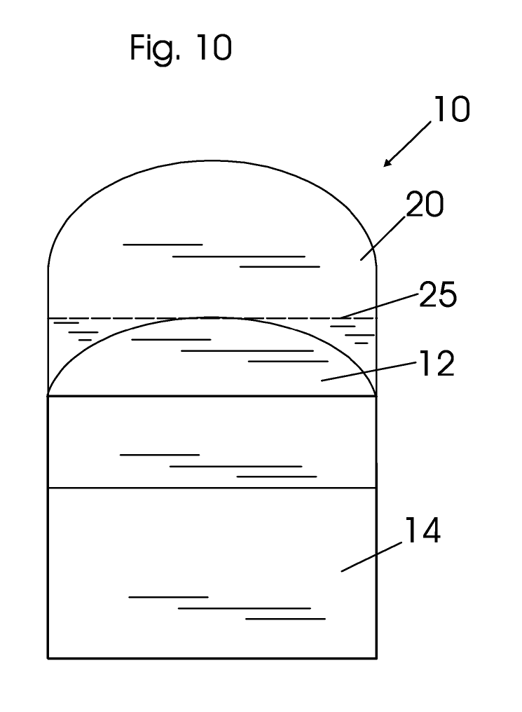

FIG. 9 shows a bottom isometric perspective view of the apparatus 10 in a partially opened or partially closed state, and shown with section 12c of the bottom 12 lifted or folded upwards. FIG. 10 shows a bottom orthographic view of the apparatus 10 in a fully closed state.

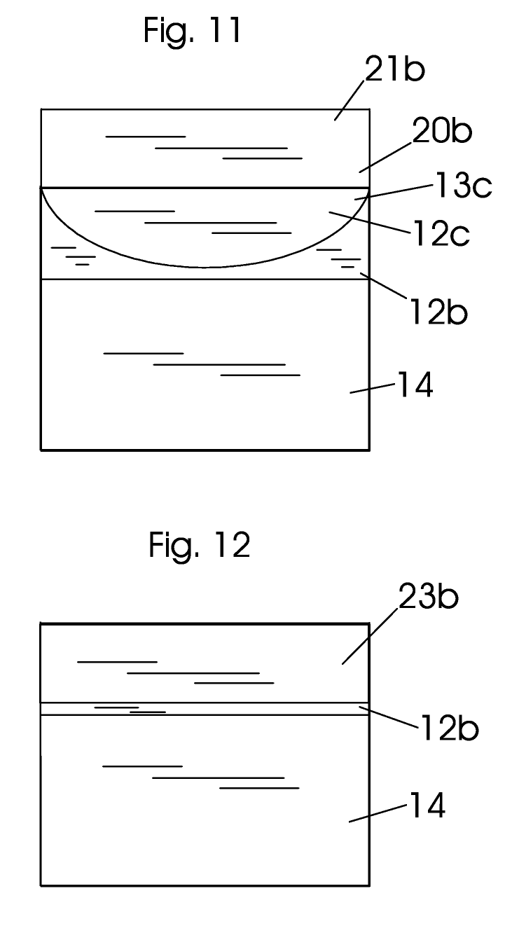

FIG. 11 shows a bottom orthographic view of part of the apparatus 10 after the sections 20a and 20b of the top 20 have been removed from the apparatus 10 and after the section 12c has been folded over so that an inner surface 13c can be seen.

FIG. 12 shows a bottom orthographic view of part of the apparatus 10 after the sections 20a and 20b of the top 20 have been removed from the apparatus 10, after the section 12c has been folded over, and after the section 20b has been folded over and sealed to section 12b and/or surface 13c of the section 12c.

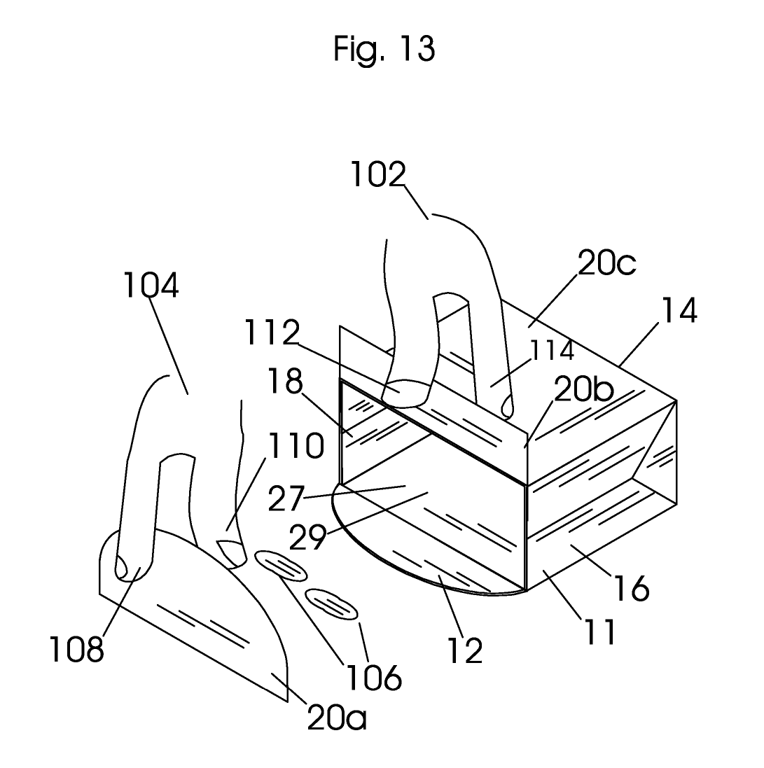

FIG. 13 shows an isometric perspective view of the top section 20a being used to move pet droppings 106 into the remaining part of the apparatus 10.

In operation, an individual tears the section 20a from the rest of the apparatus 10 along the set of perforations or perforated line 25. The individual then uses the section 20a to push or otherwise move the pet droppings 106 as shown in FIG. 13 into the remaining part of the apparatus 10, which can be called container 11. The droppings 106 are pushed through the opening 27 into the chamber 29 within the container 11. The individual typically would hold a portion of the section 20a between a finger 108 and a thumb 110 of one hand and push the droppings into the chamber 29, while holding section 20b of the container 11 between a finger 114 and a thumb 112 of a second hand 102. Using the section 20a allows a user to move the pet droppings 106 or waste, without feeling the droppings 106. If one were to instead use a plastic bag to pick up the pet droppings 106, one would typically feel the droppings 106 through the plastic bag, which would be unpleasant for an individual.

After the droppings 106 have been moved into the chamber 29 of the container 11, the individual also places the section 20a into the chamber 29. Next, the individual pushes the top 20 and the bottom 12 towards each other as shown in FIG. 9 (except without not including the section 20a) so that the left and right sides 16 and 18, and bottom 12 fold as shown in FIG. 9. When the bottom 12 and top 20 have been brought as close together as possible with the droppings 106 and the section 20a inside of the chamber 29, the section 12c is folded over so that side 13c is showing as shown in FIG. 11. The bottom 12 is typically folded into the chamber 29. Then the section 20b is folded over from the position of FIG. 11 to the position of FIG. 12, and the container 11 is sealed by sealing or attaching a surface 21b of the section 20b to surface 13c of section 12c and/or to section 12b. In one embodiment, adhesive material, usually peelable on surface 21b of section 20b in FIG. 7, will adhere to section 12b to completely seal the top of the box structure.

The container 11 having now been sealed with the section 20a and the droppings 106 inside, can now be thrown away.

The surface 21b may have an adhesive tape placed on it, which can be pealed off, to expose an adhesive or sticky surface. The adhesive tape can be placed into the chamber 29 of the container 11. The sticky surface then adheres to the sections 12c or 12b when folded over from the position in FIG. 11 to the position in FIG. 12.

The apparatus 10, and/or the container 11 of the apparatus 10, can be made of a water proof material. The container 11 when sealed as in FIG. 12 may be designed to have a completely sealed chamber 29, such that solids or liquids will not leak out of the sealed chamber 29.

The rectangular box shape of container 11 may be replaced by a box of another shape. Different sizes may be provided for the apparatus 10 and/or the container 11.

The section 20c may be a square section which may be four to six inches in length and width. Similarly, the combination of sections 12a and 12b may be a square section which may be four to six inches in length and width.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An apparatus comprising:
a top;
a bottom;
a left side;
a right side;
a rear;
wherein the top is comprised of first, second, and third sections;
wherein the first section of the top is attached to the second section of the top in a manner which allows the first section of the top to be easily removed from the second section of the top;
wherein the third section of the top, the left side, the right side, the rear, and at least a portion of the bottom form an open box structure having an opening leading to a chamber bordered by the third section of the top, the left side, the right side, the rear, and the portion of the bottom; and
wherein the second section of the top is adapted to be folded over and adhered to the bottom and thereby adapted to substantially cover the opening of the box structure so that the chamber is substantially closed.

2. The apparatus of claim 1 wherein
the open box structure is configured so that the open box structure can be placed in an expanded state in which material can be inserted through the opening into the chamber; and
wherein the open box structure is configured so that the open box structure can be placed in a fully compressed state in which material cannot be inserted through the opening into the chamber.

3. The apparatus of claim 1 wherein
the open box structure is comprised of a water proof material.

4. The apparatus of claim 1 wherein
the first section of the top is attached to the second section of the top by a perforated section.

5. The apparatus of claim 1 wherein
the third section of the top is substantially square with a length and a width between four and six inches.

6. A method comprising
detaching a first section of a top from a second section of the top;
after detaching the first section of the top, using the first section of the top to sweep pet droppings into an open box structure;
wherein the open box structure is comprised of a portion of the bottom, a left side, a right side, a rear, and a third section of the top;
wherein the third section of the top is attached to the second section of the top;
wherein the open box structure has an opening leading to a chamber bordered by the third section of the top, the left side, the right side, the rear, and the portion of the bottom;
wherein the pet droppings are swept through the opening into the chamber;
and further comprising after sweeping the pet droppings into the chamber, closing the open box structure by folding the second section of the top and attaching the second section of the top to the bottom of the open box structure to thereby cover the opening and substantially closed the chamber.

7. The method of claim 6 wherein
the open box structure is configured so that the open box structure can be placed in an expanded state in which material can be inserted through the opening into the chamber; and
wherein the open box structure is configured so that the open box structure can be placed in a fully compressed state in which material cannot be inserted through the opening into the chamber.

8. The method of claim 6 wherein
the open box structure is comprised of a water proof material.

9. The method of claim 6 wherein
the first section of the top is attached to the second section of the top by a perforated section.
